(19) United States
(12) Patent Application Publication
(10) Pub. No.: US 2026/0213392 A1
(43) Pub. Date: Jul. 23, 2026

(54) APPARATUS AND ASSOCIATED METHODS AND USES

(71) Applicant: AGC GLASS EUROPE, Louvain-la-Neuve (BE)

(72) Inventors: Günther SALME, Gosselies (BE); Damien BIHR, Gosselies (BE)

(73) Assignee: AGC GLASS EUROPE, Louvain-la-Neuve (BE)

(21) Appl. No.: 19/104,446

(22) PCT Filed: Sep. 18, 2023
(86) PCT No.: PCT/EP2023/075691

§ 371 Date: Feb. 18, 2025

(30) Foreign Application Priority Data
Sep. 20, 2022 (EP) 22196469.5

(51) Int. Cl. H01Q 1/12; H01Q 1/38; H01Q 3/02; H01Q 9/28

(52) U.S. Cl. CPC H01Q 1/1214; H01Q 1/125; H01Q 1/38; H01Q 3/02; H01Q 9/285

(57) ABSTRACT

An apparatus includes a planar antenna system which includes at least a dielectric substrate designed to receive and transmit electromagnetic waves at a range of working frequencies of between 350 MHz and 110 GHz. The apparatus further includes a fixation system designed to fix the antenna system to an object. The fixation system includes an object fixing part designed to fix the apparatus to the object, an antenna fixing part designed to maintain the dielectric substrate of the planar antenna system into the apparatus and a tilting system designed to orient the radiation of the planar antenna system towards a desired direction. The fixation system further includes a locking means designed to lock the fixation system and the orientation of the radiation of the antenna system in the desired direction.

### TECHNICAL FIELD

The present invention relates to an apparatus comprising an antenna system designed to receive and/or transmit electromagnetic waves at a range of working frequencies comprised between 350 MHz and 110 GHz, in general and, more specifically, to an enhanced apparatus to orient the radiation of the antenna system towards a desired direction.

Thus, the invention concerns multiple domains where an apparatus comprising an antenna system is used and can be fixed to an object, such a stationary object, for instance a building, a wall, a ceiling, or an urban furniture, or mounted on a mobile object, for instance a vehicle, a train, a plane, . . .

### BACKGROUND ART

Mobile data traffic is increasing continuously and will boom significantly with 5G, putting mobile network operators under CAPEX pressure. Higher frequency bands for 5G mean more challenges for coverage deployment, especially in dense urban areas where capacity will be needed and strict EMF limitations apply. The deployment of small cells are described as a good solution for capacity improvement which requires to install a large number of antennas in order to stably perform electromagnetic wave transmission and reception. However, many drawbacks limit the deployment of small cells. First, it is very difficult to find location for new antennas. Second, bringing fiber and electricity outdoor is costly. Finally, urbanistic regulations may limit possibilities for small cells.

On the other hand, in recent years with miniaturization and the introduction of IoT and Wi-Fi 6E, antennas are increasingly installed in buildings. When installing the antenna in the building, it is necessary to select the proper placement of the antenna so that electromagnetic waves can be transmitted and received stably while preventing the appearance of the building from being impaired.

However, the proper placement is not always compatible with antennas and their radiations.

In addition, when existing antennas are installed is not possible to adapt the direction of their radiation.

On top of that, repairing, replacing, adding functionalities to antenna is complicated without changing the whole apparatus.

Finally, it is crucial that the apparatus can be still integrated seamlessly into its surrounding installation environment.

### SUMMARY OF INVENTION

The present invention relates, in a first aspect, to an apparatus comprising a planar antenna system, comprising at least a dielectric substrate, designed to receive and transmit electromagnetic waves at a range of working frequencies comprised between 350 MHz and 110 GHz. The apparatus further comprises a fixation system designed to fix the antenna system to an object.

The solution as defined in the first aspect of the present invention is based on that the fixation system comprises an object fixing part, an antenna fixing part and a tilting system designed to orient the radiation of the antenna system towards a desired direction. The antenna fixing part is designed to maintain the dielectric substrate of the planar antenna system into the apparatus

The solution as defined in the first aspect of the present invention is also based on that the fixation system further comprises a locking means designed to lock the fixation system and the orientation of the radiation of the antenna system in the desired direction.

Preferably, the locking means comprises a bold and a nut-like element to easily orient and maintain the antenna system. It is understood that the bold can be a screw or alike. In such embodiments, the invention allows to orient and maintain the antenna system with the pressure of a very accessible single bold.

Thus, the invention can also solve the need to define, orient and maintain the radiation of the antenna system towards the desired direction while in the targeted position of any object fixed to the fixation, with simplicity such as with only a bold and a nut-like element.

The invention permits to obtain an apparatus that blends in with the background, decor and environment without or few visual disturbance, while having equivalent or better performances.

The present invention relates, in a second aspect, to a method to install to an object an apparatus according to the first aspect to receive and/or transmit electromagnetic waves at a range of working frequencies comprised between 350 MHz and 110 GHz to a desired direction.

The solution as defined in the second aspect of the present invention is based on that the method comprises following steps:
Fixing the object fixing part to the object;
Fixing the antenna system to the antenna fixing part;
Tilting the tilting system to orient the radiation of the antenna system towards the desired direction.

The present invention relates, in a third aspect, to a method to change an antenna system of an apparatus according to the first aspect already mounted to an object.

The solution as defined in the third aspect of the present invention is based on that the method comprises following steps:
Unfixing the antenna system from the antenna fixing part;
Providing another antenna system;
Fixing the another antenna system to the antenna fixing part.

The present invention relates, in a fourth aspect, to a method to orient the radiation of the antenna system of an apparatus according to the first aspect towards a desired direction.

The present invention relates, in a fifth aspect, to an use of a tilting system to orient the radiation of the antenna system comprised in an apparatus according to the first aspect towards a desired direction; the apparatus is designed to be mounted to an object.

It is noted that the invention relates to all possible combinations of features recited in the claims or in the described embodiments.

The following description relates to building urban applications, building, poles, traffic network, public furniture . . . but it's understood that the invention may be applicable to others fields like automotive or transportation applications.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic sectional view of an apparatus according to a first embodiment of the invention mounted on a ceiling.

FIG. 2 is a schematic sectional view of an apparatus according to a first embodiment of the invention mounted on a partition.

FIG. 3 is a schematic 3D view of an apparatus according to a first embodiment of the invention.

FIG. 4 is a schematic side view of an apparatus according to the first embodiment of the invention.

FIG. 5 is a schematic 3D view of an apparatus according to the first embodiment of the invention in a mounted position, mounted on a ceiling.

FIG. 6 is a sectional 3D view of the apparatus of FIG. 5 along plane AA′.

FIG. 7 is a sectional 3D view of the apparatus of FIG. 5 along plane BB′.

FIG. 8 is a sectional side view of the apparatus of FIG. 5 along plane BB′.

FIG. 9 is a exploded 3D view of an apparatus according to the first embodiment.

FIG. 10 is a schematic sectional side view of an apparatus according to a second embodiment mounted on a partition.

FIG. 11 is a schematic sectional top view of an apparatus according to a second embodiment mounted on a partition.

FIG. 12 is a schematic view of a method according to the second aspect of the present invention.

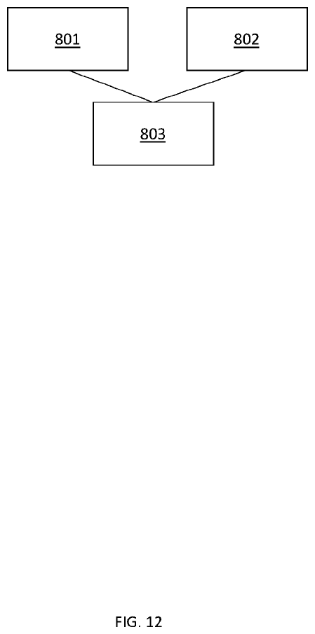

### DETAILED DESCRIPTION

In this document to a specific embodiment and include various changes, equivalents, and/or replacements of a corresponding embodiment. The same reference numbers are used throughout the drawings to refer to the same or like parts. Other variations can be envisaged within the scope of the claims.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated. herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

It is an object of the present invention to alleviate the above described problems and to remove the barriers to network densification as well as 5G private networks and WLANs when antenna systems need to be integrated with other functionalities such as signages and indicator lights but still need to be installed seamlessly onto their surrounding environment while keeping the possibility to adapt and to orient the radiation of the antenna system towards a desired direction.

Especially, the object of the first aspect of the present invention can be used for indoor and/or outdoor use. Thus, antenna systems of the present invention can receive and/or transmit electromagnetic waves at a range of working frequencies comprised between 350 MHz and 110 GHz from the indoor to the outdoor, from the indoor to the indoor, from the outdoor to the outdoor and/or from the outdoor to the indoor.

According to a first aspect of the invention, the invention relates to an apparatus 1 comprising an antenna system 2 designed to receive and transmit electromagnetic waves at a range of working frequencies comprised between 350 MHz and 110 GHz.

The antenna system comprises at least one antenna element. Each antenna element can radiate in the same range of frequency or in a different range of frequency depending of the desired application.

In some embodiments, the antenna system is a 3D antenna system meaning an antenna element having a 3D shape.

In some preferred embodiments, the antenna system is a planar antenna system. A planar antenna system is an antenna system comprising a planar antenna element such as patch antenna.

The planar antenna system has typically a width and/or a length comprised between 20 mm to 900 mm for example a rectangular shape of 210 mm×250 mm, a rectangular shape of 150 mm×160 mm or rectangular shape of 255 mm×500 mm depending of the operating frequencies, the number of elements comprised in the planar antenna system and/or the transparency design.

The apparatus further comprises a fixation system 3 designed to fix the antenna system 2 to an object, such as a ceiling 100, a partition 101, a wall The fixation system 3 comprises an object fixing part 32, an antenna fixing part 31 and a tilting system 33 designed to orient the radiation of the antenna system towards a desired direction.

A desired direction is a direction in which the antenna system is radiating to optimize the radiation towards a desired point in the space, such as another apparatus, a terminal, a CPE, a user, or alike.

In some embodiments, the antenna system can be a directional planar antenna system. In such embodiments, the desired direction correspond to the main beam of said directional antenna system.

In some embodiments, the planar antenna system can be tilted within a hemi-sphere thanks to the tilting system.

The planar antenna system 2, especially the dielectric substrate, can have any shape that are compatible with a fixation into an antenna fixing part 31.

The antenna fixing part can have any shape that is compatible with dimensions of the antenna system to be fixed on.

In some embodiments, in which the antenna system comprises an air gap, the antenna fixing part can comprises several slots or housings to accommodate the various parts of the antenna systems to maintain said various parts at the desired distance from each other.

Preferably, the antenna system works for 4G and/or for 5G, meaning wavelengths with frequencies from 690 MHz to 110 GHz, and/or for Wi-Fi, meaning wavelengths with frequencies from 2.4 GHz to 7.2 GHz.

In some embodiments, especially for Wi-Fi antenna elements, the electronics can be remove or preferably integrated to the apparatus and preferably to the fixation system.

According to some preferred embodiments, the antenna system comprises a dielectric substrate on which at least one planar antenna element is attached.

According to some embodiments, the dielectric substrate of the antenna system can be a PCB. The antenna system can comprises at least an antenna element placed on a PCB material. In such embodiments, the antenna system is not transparent, meaning opaque.

In preferred embodiments, the antenna system is at least partially transparent, preferably the antenna system is a transparent antenna system, to enable seamless indoor or outdoor placement in line with urban aesthetics constraints. Preferably, the at least partially transparent antenna system is a at least partially transparent planar antenna system. In such embodiments, the dielectric substrate can be at least partially transparent.

The term “transparent” denotes a property illustrating the average TL (light transmission) of visible light transmitted through a material in the visible spectrum of at least 1%. Preferably, transparent relates to a TL property of at least 10%. More preferably, transparent denotes a TL of at least 50%. Ideally, transparent denotes a TL of at least 70%.

A dielectric substrate of a transparent planar antenna system, according to the present invention, can be made of layers of dielectric material, such as glass, polymer-based, air gap or alike and conductive elements forming an planar antenna system. A dielectric panel is a panel that is not electrically conductive.

In some preferred embodiments, the antenna system, especially a planar antenna system, can comprise several dielectric and conductive layers and interlayers to separate dielectric and conductive layers forming at least one antenna element.

An Interlayer can be transparent polymer interlayer or a gap filled of gas, such as an air gap.

Such transparent interlayer are preferably transparent polymer film. Preferably, transparent polymer film can be polyvinyl butyral (PVB), ethylene-vinyl acetate (EVA), polymethyl methacrylate (PMMA), a polycarbonate (PC), a polystyrene (PS), a polyvinyl chloride (PVC), a polyamide (PA), a polyetherimide (PEI), a polyethylene terephthalate (PET), a polyurethane, an acrylonitrile butadiene styrene copolymer (ABS), a styrene acrylonitrile copolymer (SAN), a styrene methyl methacrylate copolymer (SMMA) and any mixtures of these, a crosslinked resin, an ionoplast, an ionomer, a cyclo-Olefin copolymer (COC), cyclo-Olefin polymer (COP) or an Optical Clear Adhesive (OCA).

The material of conductors of the antenna can be realized by screen-printing, inkjet printing, deposition, glued wire, copper foil, copper mesh, or alike.

The planar antenna system can be transparent, partially transparent or opaque depending on the desired application and depending on sizes and emission direction of the lighting system.

For instance, a transparent planar antenna system is an antenna as described in the international publication WO2022101498.

According to the invention, the planar antenna system can comprise a dielectric substrate made of glass meaning that at least one layer is a glass substrate. The material of the glass substrate can be, for example, soda-lime silica glass, borosilicate glass, aluminosilicate glass or other materials such as thermoplastic polymers or polycarbonates which are especially known for automotive applications. References to glass throughout this application should not be regarded as limiting.

The glass substrate can be manufactured by a known manufacturing method such as a float method, a fusion method, a redraw method, a press molding method, or a pulling method. As a manufacturing method of the glass substrate, from the viewpoint of productivity and cost, it is preferable to use the float method.

In some embodiments according to the invention, the planar antenna system can comprises several glass substrates separated by at least one interlayer.

Glass substates can be independently processed and/or coloured, . . . and/or have different thickness in order to improve the aesthetic, thermal insulation performances, safety, . . .

The thickness of the planar antenna system and thus the material used is set according to requirements of applications.

The glass substrate can independently be a clear glass or a coloured glass, tinted with a specific composition of the glass or by applying an additional coating or a plastic layer for example. The glass substrate can have any shape to fit to the opening such as a rectangular shape, in a plan view by using a known cutting method. As a method of cutting the glass substrate, for example, a method in which laser light is irradiated on the surface of the multi-glazed window to cut the glass substrate, or a method in which a cutter wheel is mechanically cutting can be used.

The shape of the planar antenna system in a plan view is usually a rectangle. Depending of the application, the shape is not limited to a rectangle and may be a trapeze, a triangle, a circle, a hex or the like.

A glass substrate has generally a first and a second surface separated by the thickness of the glass substrate. The first and the second surfaces can be substantially parallel. In some embodiments, the thickness of the glass substrate can vary along a plane and thus the first and the second surfaces are not parallel.

In some embodiments, the first and/or the second face of the glass substrate can be partially etched with a specific design.

In some embodiments, a decorative layer(s), for example an inkjet printing layer(s), is applied on at least a part of the first and/or on the second face.

The following description relates to planar antenna system but it's understood that the invention may be applicable to others type of antenna systems such as 3D antenna systems.

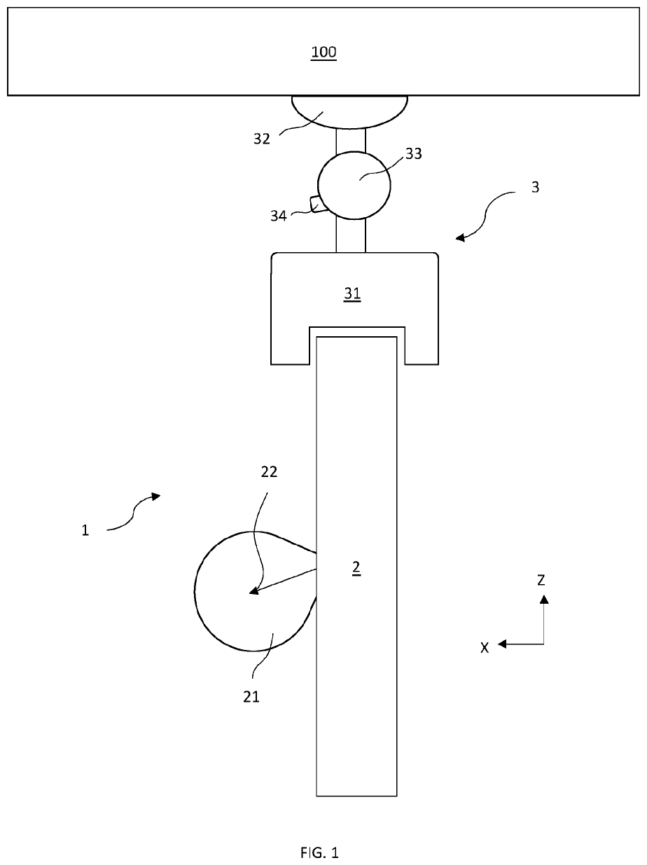

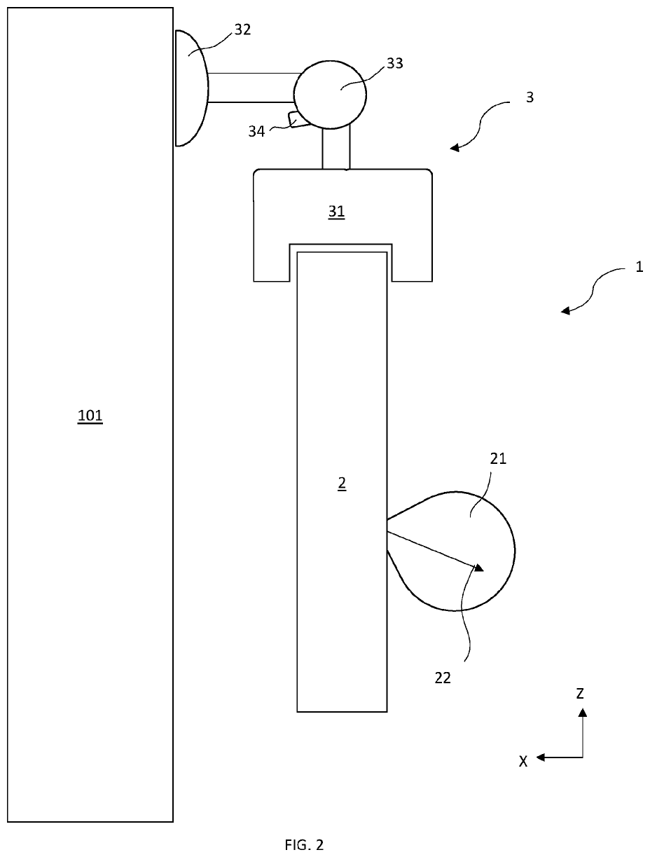

FIG. 1 and FIG. 2 illustrate some embodiments of an apparatus 1 according to the invention and fixed to an object, such a ceiling 100 or a partition 101. The apparatus 1 comprises a planar antenna system 2 and a fixation system 3.

The fixation system 3 comprises an object fixing part 32, an antenna fixing part 31 and a tilting system 33 designed to orient the radiation 21 of the planar antenna system towards a desired direction 22.

According to the invention, the fixation system can be made of plastic-based material, steel, aluminium, stainless steel or any knew material to be used as a fixation system.

FIG. 1 shows an planar antenna system fixed to a ceiling 100 meaning that the apparatus is fixed to the ceiling 100.

FIG. 2 shows an planar antenna system fixed to a partition or a wall 100 meaning that the apparatus is fixed to the ceiling 100.

The apparatus of the present invention can be mounted on a flat surface or curved or bumpy surface horizontally or vertically. Thanks to the tilting system, the apparatus can also be fixed to a wall that is neither horizontal nor vertical while having an antenna with the orientation of the radiation 22 of the planar antenna system in the desired direction.

According to the invention, the fixation system comprises an object fixing part 32.

The object fixing part 32 is designed to fix the apparatus to the object 100, 101. The object fixing part can comprises a hole, to let a screw passing through to be fix directly or indirectly to the object. The object fixing part can comprises a clamping system to clip the apparatus on the object. It is understood that the object fixing part can have any elements that can permit to fix an apparatus according to the first aspect of the present invention to an object.

According to the invention, the fixation system comprises an antenna fixing part 31.

The antenna fixing part 31 is designed to maintain the planar antenna system into the apparatus and thus to the fixation system to be fixed to an object.

The antenna fixing part can comprises a mechanical clamping system, a glue, a tape or any other system able to maintain the planar antenna system into the fixation system.

According to the invention, The fixation system comprises a tilting system 33 designed to orient the radiation 21 of the planar antenna system towards a desired direction 22. The tilting system 33 permits to adapt the direction 22 of radiation 21 of the planar antenna system via the antenna fixing part 31.

In some embodiments according to the invention, the tilting system can comprise a first axial rotation system able a rotation Ry on at least one axis of rotation RAy of the planar antenna system.

In some embodiment, according to the invention, the tilting system can comprise a second axial rotation system RAz able a rotation Rz on at least one axis of rotation RAz of the planar antenna system and substantially perpendicular to the first axial rotation system.

According to the invention, the tilting system can be a mechanical tilting system to easily handle, manipulate and/or assemble the apparatus.

In some embodiments, the tilting system can be an electronic tilting system. Especially for reception, The apparatus can further comprises a smart electronic connected to the antenna system parameters and the tilting system. The tilting of the antenna system can be performed electrically and automatically to change the orientation of the antenna system if the signal drops below a certain level for example in order to have always good signal.

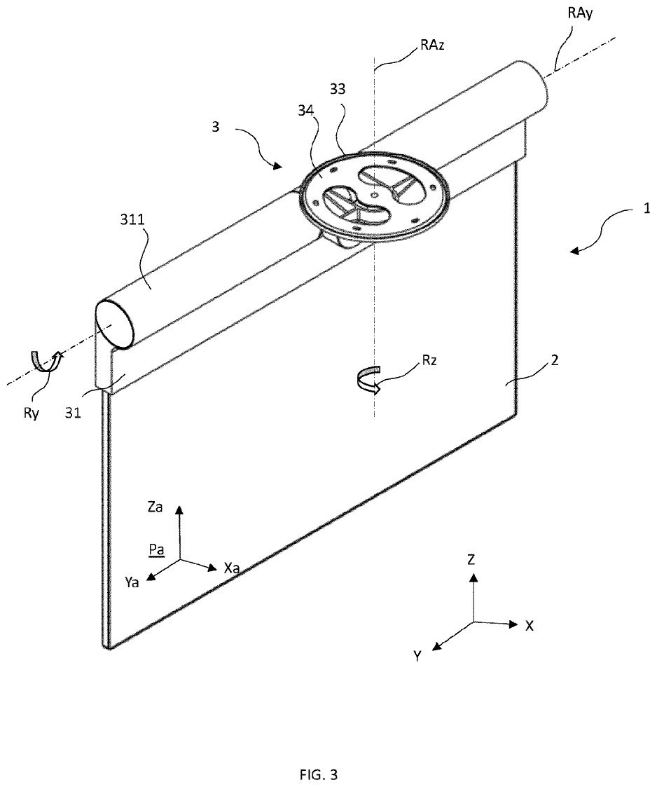

FIG. 3 illustrates a first embodiment of an apparatus 1 comprising a planar antenna system 2 clamped a antenna fixing system 31. The clamping can be made with screws for example or any other way to ensure the clamping of the planar antenna system into the fixation system.

In such embodiments, the planar antenna system 2 has a generic shape of a rectangular parallelepiped extending along a plane, Pa, defined by a longitudinal axis, Xa, and a vertical axis, Za; having a width, Wg, measured along the longitudinal axis, Xa, a thickness Yg measured along the Y-axis and a height, Zg, measured along the vertical axis, Za.

The planar antenna system can emit in any direction, on one side, i.e. +X, on the other side, i.e −X, or on both sides, depending on the specific application.

In this first embodiment, the orientation of the radiation of the planar antenna system is performed by a first axial rotation system 311 along the axis of rotation RAy and by a second axial rotation system 34 along the axis of rotation RAz. Meaning that the plane Pa defining one surface of the planar antenna system can be orientate in the space represented by generic coordinate X-, Y- and Z-axis.

It is understood that according to the invention, the orientation of the orientation of the radiation of the planar antenna system can be performed by a single axial rotation system.

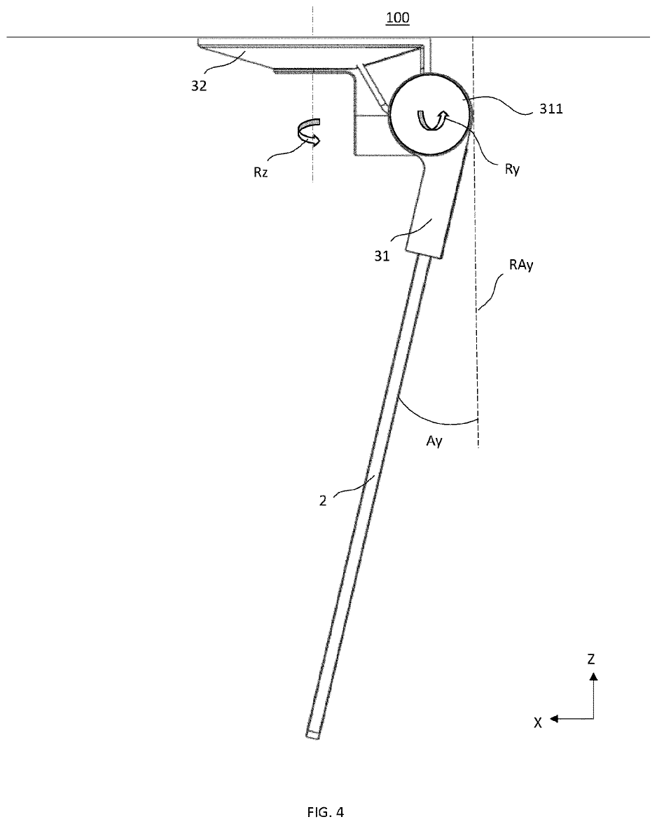

FIG. 4 illustrates an orientation of the planar antenna system by the first axial rotation system 311 along the axis of rotation Ray creating a angle Ay between the plane X-Z (perpendicular to the ceiling 100).

Depending of the application, the angle Ay can be comprises −90° to 180°, the vertical position being 0°. In some applications, the angle can be less than −90° and/or more than 180°.

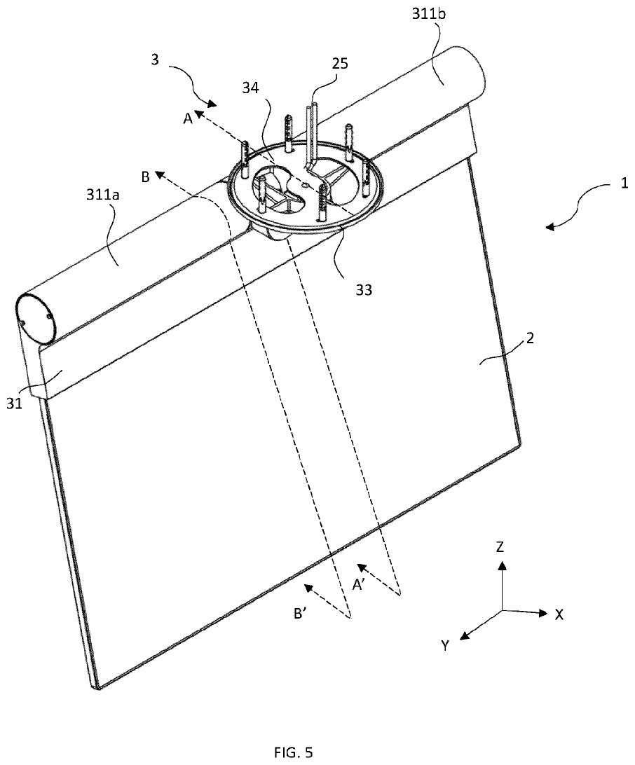

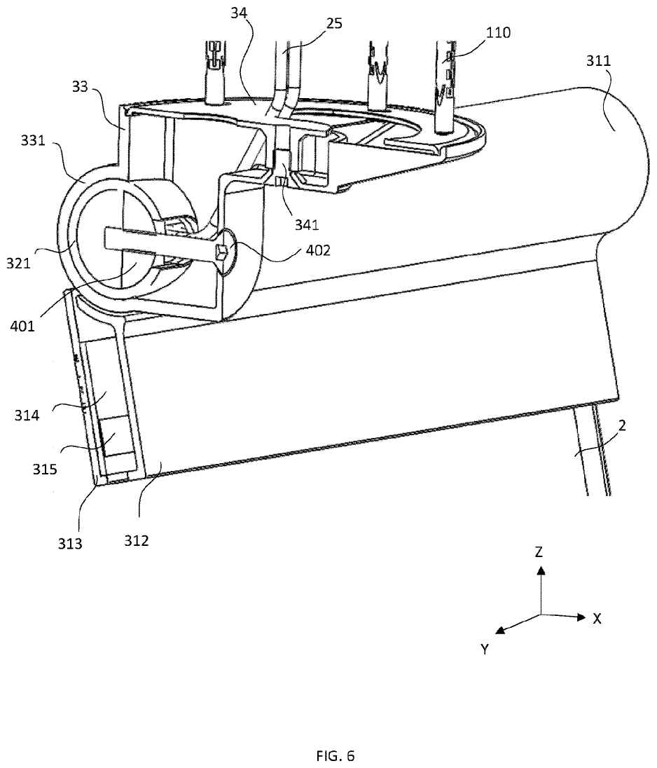

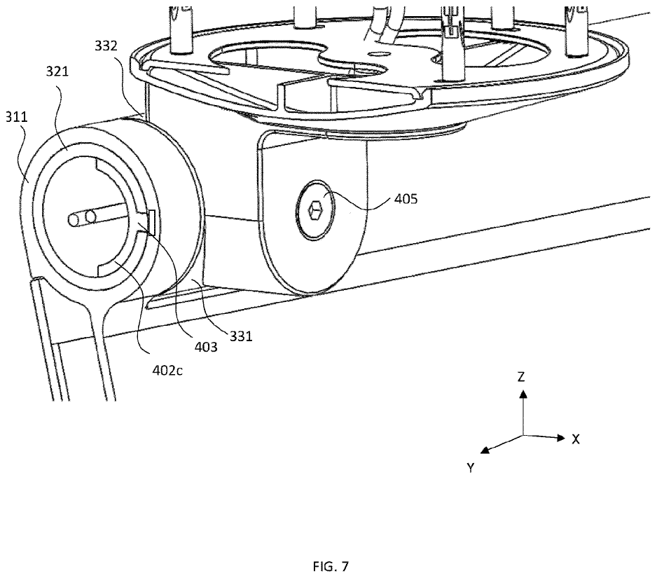

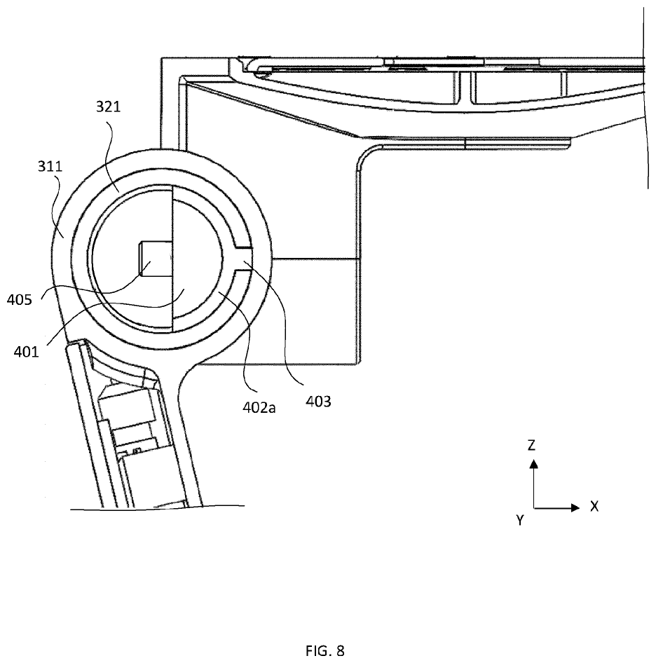

FIG. 5, FIG. 6, FIG. 7 and FIG. 8 illustrate an apparatus 1 attached to a ceiling (not shown) by screws and plugs 110.

In some embodiments, the apparatus comprises at least one cable 25 connected to the planar antenna system 2 to feed the at least one antenna element.

FIG. 6 illustrates an embodiment in which the tilting system comprises a first axial rotation system. The first axial rotation system comprises an external rigid hollow cylinder 311 attached to the antenna fixing part and an internal rigid hollow cylinder 321 attached to the object fixing part.

In such embodiments, the rigid hollow cylinder and at least a part of the antenna fixing part form a single piece.

The term rigid means a system, an element, a part that is keeping his structural shape with a deformation of less than 5%.

The term hollow means that the cylinder is not completely full, such as a tube. Preferably, a hollow cylinder is a cylinder having an interior wall extending from one edge to the other.

The locking means can comprise a nut-like element 401 and a bolt 405; The nut-like element being inside the internal rigid hollow cylinder.

Preferably the external wall of the internal rigid hollow cylinder corresponds to the internal wall of the external rigid hollow cylinder.

FIG. 6 illustrates also an embodiment to clamp the planar antenna system. The antenna fixing system can comprises a front part 312 and a back part 313 designed to clamp the planar antenna system, especially the dielectric substrate, while easily mount and/or unmount the planar antenna system.

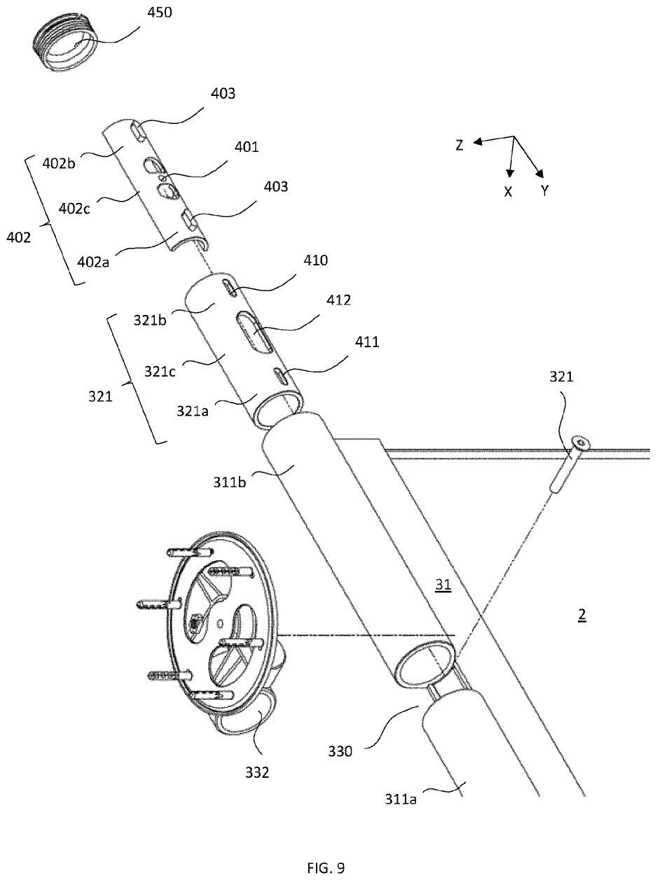

In such embodiments, as illustrated in FIG. 6 and FIG. 9, the front part 312 and the external rigid hollow cylinder 311 are a single piece. The back part 313 is attached to the front part 312 to clamp a part of the dielectric substrate of the antenna system. In such manner, the antenna system is attached to the external rigid hollow cylinder and then to the apparatus.

In some embodiments, the back part and/or the front part can have at least one hole to let a screw or alike passing through it and pressing the planar antenna system or passing thought the planar antenna system to fix it.

In some other embodiments, to avoid any hole in the planar antenna system, especially in the dielectric substrate of the antenna system, to reduce risk of breakage and/or interferences with antenna element, the planar antenna system can comprise a fixing element 314 attached to the planar antenna system 2, especially the dielectric substrate of the antenna system; the fixing element is designed to be attached to the antenna fixing part, especially the dielectric substrate of the antenna system. The fixing element can be attached by a glue, a double side tape 315 to the planar antenna system, especially to the dielectric substrate of the antenna system. In some embodiments, the fixing element can be laminated directly to the planar antenna system, especially to the dielectric substrate of the antenna system. The fixing element can have hole able to receive a screw to fix the fixing element to the back part, or to the front part.

FIG. 7 and FIG. 8 illustrate a locking means 402 comprising an pressure element comprising a spur 403. The spur 403 is attached to a lateral extension 402a, 402c of the nut-like element 401. The internal rigid hollow cylinder comprises at least one opening 410, 411 designed to let the spur passing through the opening. By screwing the blot 405, the nut-like element brings closer to the outside (+X) and the spur can press on the interior wall of the external rigid hollow cylinder, blocking the rotation and thus the position of the planar antenna system.

In such embodiments, as illustrated in FIG. 3 to FIG. 9, the front part 312 of the antenna fixing part 31 and the external rigid hollow cylinder 311 of the first axial rotation system are manufactured in a single piece.

In said embodiments, the external rigid hollow cylinder 311 can have an opening 330 substantially in the middle of the length creating a left external rigid hollow cylinder part 311a and a right external rigid hollow cylinder part 311b. The said opening allows the relationship with at least a part of the tilting system 33. The internal rigid hollow cylinder 321 of the tilting system is placed inside the external rigid hollow cylinder. The diameter of the external surface of the internal rigid hollow cylinder 321 is lower than the diameter of the internal surface of the external rigid hollow cylinder 311 to avoid friction and/or blockages in order to reduce wear on the cylinders and increase their service life. Preferably, the difference of diameters is about 0.1 mm, more preferably the minimum difference of diameters is about 0.05 mm.

Thus, in such embodiments, the internal rigid hollow cylinder 321 can constitute the main axis for the rotation of the antenna system while connecting the external rigid hollow cylinder 311 and the antenna fixing part to cylinder 332 of the object fixing part. It means that with a simple manipulation and blocking via the locking means, the operator can orient the antenna system to the desired direction.

In such embodiments, a single easily accessible bold 405 exercise a pressure on nut-like toward inner cylinder 311 via the spur 403 to cause a strong break when screwing. A slight reverse action on the screw 402 releases the brake action while maintaining sufficient friction between the internal surface of the external rigid hollow cylinder and the external surface of the internal rigid hollow cylinder allowing the rotation Ry, meaning bottom to sky rotation, of the antenna system via the antenna fixing part and the external hollow rigid cylinder and the direction of the planar antenna securely by the action of the operator. The peripheric direction in the Z-axis, possibility of a 360° orientation, is held by the fixation to the object, wall, ceiling, pole, . . . and blocked by the fixation screw 341 locking the fixation embodiment 33 to the object fixing element 34.

The bold 405, that can correspond to a pressure screw, is not fixed to any other element than the nut-like element. Just related to pressure the nut-like element 401 attached to its lateral extensions 402a, 402b from which are attached the a spur 403 which length exceed from about 0.1 the thickness of the internal rigid hollow cylinder 321.

The length of the external rigid hollow cylinder depends on the application and the number of antenna elements comprised in the antenna system. For example, for two 5G antenna elements, with 4-ports, comprised in the antenna system, the length of the external rigid hollow cylinder can be about 42 cm or 21 cm depending on the specific configuration of the 5G antenna elements, for a Wi-Fi antenna element, the length can about 21 cm.

Preferably, the length of internal rigid hollow cylinder is shorter, in the Y-axis, than the length of the external hollow cylinder to reduce the weight and easily let the at least one cable passing from the connection of the antenna system to the object fixing part.

FIG. 9 illustrates a method according to the invention to assemble some elements of the apparatus, especially the external rigid hollow cylinder 311 with a left external rigid hollow cylinder part 311 a, a right external rigid hollow cylinder part 311b and an opening 330, the internal rigid hollow cylinder 321 and the locking means 402 comprising a left part 402a with a spur 403, a right part 402b with a spur 403 and a centre part 402c.

Said method comprises a step of assembling the locking means into the internal rigid hollow cylinder while having the spur(s) passing thought the internal rigid hollow cylinder via openings 410, 411 in order to protrude from the internal rigid hollow cylinder. The nut-like element 401 is substantially in front of an central opening 412 of the internal rigid hollow cylinder.

The method also comprises a step of inserting into the opening 330 of the external rigid hollow cylinder the cylinder 332 of the object fixing part. This cylinder has substantially the same diameter than the diameter of the external rigid hollow cylinder.

The step of inserting and the step of assembling can be performed independently one before the other one.

After these steps, the method comprises a step of threading the internal rigid hollow cylinder with the locking means into the external rigid hollow cylinder until the central opening 412 and the nut-like element 401 are in front of the hole designed to let the bold 321 passing through this hole to be fixed into the nut-like-element 401. The opening 412 allows the at least one cable passing from the external rigid hollow cylinder to the object fixing means.

In such embodiment, the object fixing part can rotate along an axis Ry substantially corresponding to the centre if symmetry of the external rigid hollow cylinder 311 meaning that the angle Ay can be modified even if the object fixing part is attached to the object by a rotation of the antenna fixing part via the external rigid hollow cylinder 311. The locking means can rotate with the single piece to facilitate the handling.

In such embodiments, the internal rigid hollow cylinder extends, from the portion integrated in the opening, in the two parts 311a, 311b of the external rigid hollow cylinder 311. More preferably, to maximize stability of the apparatus, the internal rigid hollow cylinder symmetrically extends, from the portion integrated in the opening, in the two parts 311a, 311b of the external rigid hollow cylinder 311 meaning that the length of the portion of the internal rigid hollow cylinder inside the right portion 311b of the external rigid hollow cylinder is substantially the same than the length of the portion of the internal rigid hollow cylinder inside the left portion 311a of the external rigid hollow cylinder.

A cap can be added at each end of the external rigid hollow cylinder to hide, to protect the assembly while avoiding a user to manipulate cables hidden into the cylinders.

Then to adapt direction of the radiation of the planar antenna system, it is easy to unscrew the bolt 405, change the angle Ay and then screw the bolt to lock the angle.

The invention permits to unlock the orientation of the antenna system by unscrewing the bold 405 a little, just enough to unlock and keep a sensitive friction between the at least a spur 321 and the external rigid hollow cylinder 311.

Preferably, especially for outdoor usage, the apparatus can comprise milimetrical grooves on the internal surface of the external rigid hollow cylinder 311 to strongly fix the orientation of the antenna system with no possible sliding variable and to specifically resist to strong turbulences along buildings high facades, tunnels, tubes, and stormy weather.

In such embodiments, to adapt the direction of the radiation of the planar antenna system, only two bolts is enough to orient in a hemi-sphere the direction of the radiation. One can be unscrew to adapt the rotation along the Y-axis and the other along the Z-axis. This permits to orient the radiation of the planar antenna system towards any desired direction.

In some preferred embodiments, the apparatus comprises at least one cable connected to the planar antenna system and the fixation system comprises a get-through means designed to let the at least one cable passing from the antenna fixing part to the object fixing part, meaning that the cable is hidden from the outside of the fixation system.

In some preferred embodiments, the first axial rotation system comprise a get-through means designed to let the at least one cable passing from the antenna fixing part to the object fixing part. Said get-through means can comprises at least one hole in the thickness of the external rigid hollow cylinder 311. The at least one hole is preferably in an hidden part of the apparatus, meaning in the extension of the antenna system between the front part 312 and the back part 313. Then the at least one cable 25 can pass from the connection to the antenna element, by the at least one hole, by the hollow cylinder and to the object fixing part to be connected outside of the apparatus, i.e. in the ceiling.

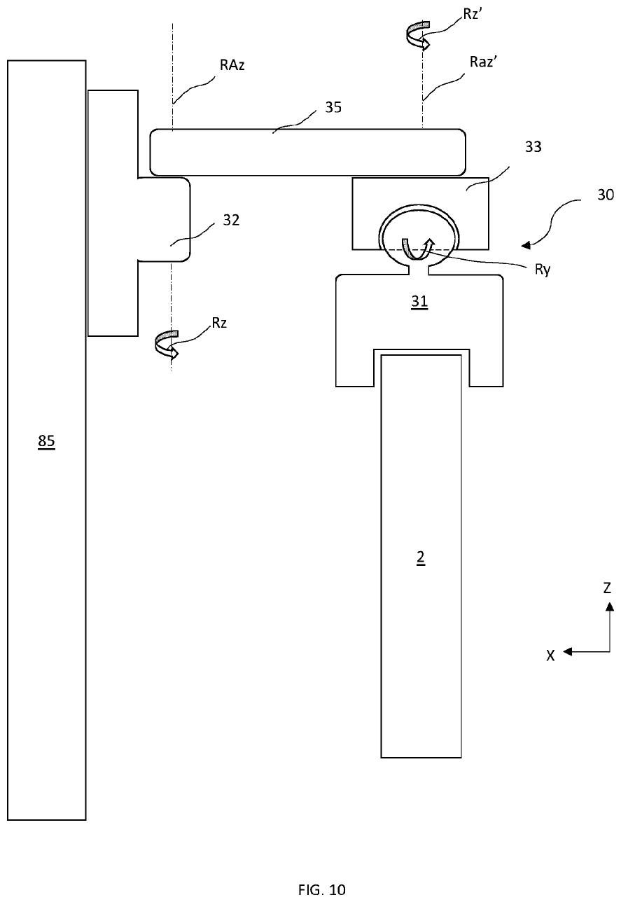

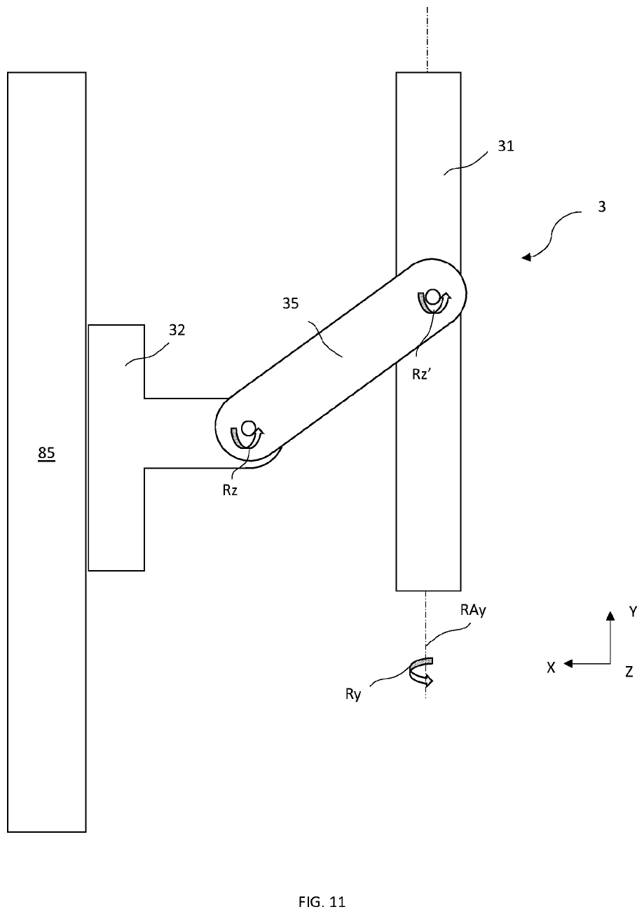

FIG. 10 and FIG. 11 illustrate some embodiments where the apparatus is fixed to a wall 101.

In some embodiments, to keep the antenna away from the wall, to avoid overheating, back radiation and/or breakage, the apparatus can comprises an arm 35. The rotation Rz is made by rotating the arm around a fixed point via an axis of rotation Raz with the object fixing element 32. Another rotation, Raz′, along the Y axis, can also be done between the arm and the planar antenna system via an axis of rotation Rz′.

The present invention relates also to a method to install to an object an apparatus according to any preceding claims to receive and/or transmit electromagnetic waves at a range of working frequencies comprised between 350 MHz and 110 GHz to a desired direction. The method comprises following steps:
Fixing 801 the object fixing part to the object;
Fixing 802 the planar antenna system to the antenna fixing part;
Tilting 803 the tilting system to orient the radiation of the planar antenna system towards the desired direction.

The step of the fixing 801 the object fixing part to the object and the step of fixing 802 the planar antenna system to the antenna fixing part can be made one before the other one.

The present invention relates also to a system comprising several apparatus according to the first aspect of the invention to create a network.

The network could be a private network, such as a Wi-Fi network, a 5G network or alike inside a building for example, depending on the antenna system used and comprised in the apparatus of the system.

During the installation of an apparatus, especially in a network, an evaluation of the optimum coverage can based on one fixed direction of the antenna system meaning that the operator can modify the tilt of each apparatus of the network to optimize the coverage.

In some cases, to avoid the modification of the coverage during the use of a system according to the invention, a locking system can be inaccessible to any users. In fact, if the direction of the radiation change after the initial coverage study by the users, this can affect the coverage zone and then the overall performance of the system.

Thus, the present invention has also the advantage to have more flexibility during the coverage study.

The present invention relates also to a method to change a planar antenna system of an apparatus according to the first aspect already mounted to an object, wherein the method comprises following steps:
Unfixing the planar antenna system from the antenna fixing part;
Providing another planar antenna system;
Fixing the another planar antenna system to the antenna fixing part.

In such method, is possible customize the radiation of the antenna system, preferably a planar antenna system, towards the desired direction by using the tilting system to orient the radiation of the antenna system towards the desired direction.

Thus, the invention solve the need to adapt, to change, to optimize and/or to orient the radiation of the antenna system towards a desired direction.

1. An apparatus comprising:
a planar antenna system comprising at least a dielectric substrate, and designed to receive and/or transmit electromagnetic waves at a range of working frequencies from 350 MHz to 110 GHz; and
a fixation system designed to fix the antenna system to an object, the fixation system further comprising:
an object fixing part designed to fix the apparatus to the object,
an antenna fixing part designed to maintain the dielectric substrate of the planar antenna system into the apparatus,
a tilting system designed to orient radiation of the planar antenna system towards a desired direction, and
a locking means designed to lock the fixation system and the orientation of the radiation of the antenna system in the desired direction,
wherein the tilting system is a mechanical tilting system,
wherein the tilting system comprises a first axial rotation system,
wherein the first axial rotation system comprises an external rigid hollow cylinder attached to the antenna fixing part and an internal rigid hollow cylinder attached to the object fixing part,
wherein the locking means comprises a pressure element comprising a spur, and
wherein the internal rigid hollow cylinder comprises an opening designed to let the spur pass through the opening and press a part of an interior surface of the external rigid hollow cylinder.

2. The apparatus according to claim 1, further comprising at least one cable connected to the planar antenna system and
wherein the fixation system comprises a get-through means designed to let the at least one cable pass from the antenna fixing part to the object fixing part.

3. The apparatus according to claim 1, wherein the tilting system further comprises a second axial rotation system (Rz) substantially perpendicular to the first axial rotation system.

4. The apparatus according to claim 1, wherein the planar antenna system comprises a glass substrate.

5. The apparatus according to claim 1, wherein the planar antenna system is at least partially transparent.

6. The apparatus according to claim 1, wherein the planar antenna system comprises a fixing element attached to the planar antenna system; the fixing element being designed to be attached to the antenna fixing part.

7. The apparatus according to claim 1, wherein the locking means comprises a bolt and a nut-like element to easily orient and maintain the antenna system in the desired direction.

8. A system comprising several apparatus according to claim 1.

9. A method for installing on an object an apparatus according to claim 1 to receive and/or transmit electromagnetic waves at a range of working frequencies from 350 MHz to 110 GHz to a desired direction, the method comprising:
fixing the object fixing part to the object;
fixing the antenna system to the antenna fixing part; and
the tilting system to orient the radiation of the antenna system towards the desired direction.

10. A method for changing a planar antenna system of an apparatus according to claim 1 already mounted to an object, the method comprising:
unfixing the antenna system from the antenna fixing part;
providing another antenna system; and
fixing the another antenna system to the antenna fixing part.

11. The method for changing the planar antenna system according to claim 10, further comprising after fixing the another antenna system to the antenna fixing part, tilting the tilting system to orient the radiation of the planar antenna system towards the desired direction.

12. (canceled)
